(19) United States
(12) Patent Application Publication
(10) Pub. No.: US 2021/0344245 A1
(43) Pub. Date: Nov. 4, 2021

(54) INSULATING UNIT FOR AN ELECTRICAL MACHINE

(71) Applicant: ZF FRIEDRICHSHAFEN AG, Friedrichshafen (DE)

(72) Inventors: Jochen WITTMANN, Burkardroth (DE); Stefan REUTER, Hammelburg (DE); Christoph WIEDER, Küps (DE); Daniel SCHMITT, Bad Bocklet (DE); Katja WILLACKER, Wiesentheid (DE); Andre GRÜBEL, Königsberg (DE); Martin HEßDÖRFER, Karlstadt (DE)

(21) Appl. No.: 17/280,285

(22) PCT Filed: Sep. 25, 2019
(86) PCT No.: PCT/EP2019/075923

§ 371 Date: Mar. 26, 2021

(30) Foreign Application Priority Data
Sep. 26, 2018 (DE) 102018216462.2
May 24, 2019 (DE) 10 2019 207 665.3

(51) Int. Cl. H02K 3/28; H02K 11/25; H02K 3/38; H02K 3/50

(52) U.S. Cl. CPC H02K 3/28; H02K 11/25; H02K 2203/09; H02K 3/50; H02K 3/38

(57) ABSTRACT

An insulating unit for an electric machine with hairpin winding having a plurality of connection pins for electrically connecting to an interconnection and a plurality of welded hairpin ends which form contact pairs. The insulating unit has a base body that has an insulating material and extends at least over a portion of the circumference of the hairpin winding, characterized in that the base body has continuous openings extending in axial direction, and in that each opening is associated with a hairpin end or a connection pin

### CROSS REFERENCE TO RELATED APPLICATIONS

This is a U.S. national stage of Application No. PCT/EP2019/075923 filed Sep. 25, 2019. Priority is claimed on German Application No. DE 10 2019 207 665.3 filed May 24, 2019 and German Application No. DE 10 2018 216 462.2 filed Sep. 26, 2018 the content of which is incorporated herein by reference.

### BACKGROUND OF THE INVENTION

### 1. Field of the Invention

The present disclosure is directed to an insulating unit for an electric machine with a winding comprising a plurality of shaped rods that pass through at least two slots spaced apart in circumferential direction and have contact points on one side of the electric machine connected to one another to form the winding. Windings of this kind are also referred to as hairpin windings or wave windings. In the following, only the designation “hairpin” or “hairpin winding” will be used, with wave windings and the like being comprehended within the meaning of the application.

### 2. Description of Related Art

It is known in the prior art in windings of electric machines, particularly of the stator, to cover uninsulated areas with an insulating potting compound. It is known for hairpin windings that the uninsulated hairpin ends which are connected to one another to form the coils are insulated at the winding head relative to one another and relative to the environment by means of a potting compound after connection. The use of closed caps is also known, for example, in JP 2000-209802 A.

Problems in the prior art consist in applying and working the potting compound, particularly with respect to sealing free from bubbles and with respect to air gaps and creepage distances to be maintained depending on the voltage level of the electric machine.

### SUMMARY OF THE INVENTION

It is an object of one aspect of the present invention to provide an insulation of the hairpin ends which is producible simply and quickly and which reliably insulates the hairpin ends.

One aspect of the invention is an insulating unit for an electric machine with hairpin winding, wherein the hairpin winding has a plurality of connection pins for electrically connecting to an interconnection and a plurality of welded hairpin ends that form contact pairs, wherein the insulating unit has a base body having an insulating material and extending at least over a portion of the circumference of the hairpin winding, is characterized in that the base body has continuous openings extending in axial direction, and in that each opening is associated with a hairpin end or a connection pin.

A hairpin winding is formed from a plurality of hairpins or shaped rods that have contact points at their ends at the winding head. Connection pins are electrically conductively connected to one another in pairs at the contact points to produce the coils of the hairpin winding from the hairpins. The contact points, which are connected to one another in pairs, are designated as hairpin ends, and the respective individual contact points at the start and end of the respective coils are designated as connection pins. The connection pins are electrically conductively connected to an interconnection in order to connect it to the power electronics for controlling the electric machine.

Positioning and handling can be appreciably facilitated through the use of an insulating unit as independent component part. The insulating unit has a base body that comprises an electrically insulating material. Plastic is preferably used as material, but embodiment forms with other electrically insulating materials such as rubber or other elastic materials or ceramic materials are also possible. The base body may be formed of one or more parts and extends at least over a portion of the circumference. Depending on the construction, the distances between the connection pins and hairpin ends can be shorter, particularly in the region of the connection pins, or the distance from hairpin ends to other electrically conductive component parts can also be short at other locations along the circumference, for which reason insulation is especially necessary in these regions. Therefore, depending on the construction of the electric machine, embodiment forms are possible in which it is sufficient that only a portion of the circumference of the hairpin winding is covered by the insulating unit. However, preferred embodiment forms have a base body on which the entire circumference of the hairpin winding and hairpin ends is covered.

To insulate the hairpin ends from one another, the base body viewed in axial direction of the electric machine has openings that extend across the thickness of the base body and are accordingly continuous. Because of the continuous openings, air can escape during a potting of the hairpin ends so that trapped air and the like can be reliably prevented. At the same time, insulation of the hairpin ends relative to one another, particularly with respect to the air gap, is improved by the material of the base body present between the openings. Every opening is associated with a hairpin end, or a contact pair comprising conductor elements which are welded together, or a connection pin.

Embodiment forms of an insulating unit are characterized in that the base body has, at its side remote of the hairpin winding, projections that serve as spacers for an interconnection arrangement. In order to prevent the continuous openings from being closed, for example, by a mounted interconnection or other component parts or damping elements, projections are provided at the base body that ensure a minimum distance between the end face of the base body with the openings and an adjacent component part. This ensures that the openings will remain passable even during potting, for example, after the interconnection has been mounted and connected, and that potting compound can enter and air can escape through the openings.

Preferred embodiment forms of an insulating unit are characterized in that the projections are arranged so as to be uniformly distributed over the circumference. A uniform distribution ensures the minimum spacing over the entire circumference, and symmetries can be utilized.

Insulating units according to further preferred embodiment forms are characterized in that the projections are not arranged directly adjacent to an opening for a connection pin. When an interconnection is connected to a connection pin, a directly adjacent projection may lead to an unwanted diminution of the creepage distance for the insulation. Therefore, there are preferably no projections provided at the material of the base body directly surrounding an opening for a connection pin; rather, the projections are arranged between openings for hairpin ends.

Further preferred embodiment forms of an insulating unit are characterized in that the projections are formed to be T-shaped. As a result of the T-shape, a reliable support can be ensured even in case of relatively few projections, and tilting can be prevented even when supported at an individual projection. Further, T-shaped projections can easily be arranged between the openings.

Embodiment forms of an insulating unit are characterized in that at least one opening has a widening for receiving a temperature sensor. Temperature sensors are used to monitor the temperature of the hairpin winding during operation. In order to enable a measurement as accurate as possible, a temperature sensor must be arranged as close as possible to, preferably touching, a conductor element of the winding. For this purpose, a winding is provided in at least one continuous opening so that the clear width of the opening is increased to allow a temperature sensor to be accommodated next to the hairpin end or connection pin. As a result of a construction of this kind, the temperature sensor is held securely and is positioned with respect to the hairpin winding. Further, the temperature sensor can be secured simultaneously with the hairpin end by the potting compound.

Embodiment forms of an insulating unit are preferably characterized in that the widening narrows along the axial extension of the opening in order to ensure that the temperature sensor abuts the hairpin winding. Due to the wedge effect brought about in this way, the temperature sensor can be better positioned and prevented from being pushed in too far until possibly emerging from the opposite side.

Embodiment forms of an insulating unit are characterized in that the base body is formed of a plurality of parts. The base body may be formed as a one-part annular body. In order to reduce the size of the individual parts and to utilize subcomponents that may possibly be partially identical distributed over the circumference or in different models of an electric machine, forming the base body from a plurality of subcomponents may be advantageous. In particular, these subcomponents have connecting features such as tongue and groove joints or other plug-in and/or snap-in connections at their contact faces facing one another so that the base body can easily be assembled to form a constructional unit.

Insulating units according to embodiment forms are characterized in that a cover plate is provided on the projections, or the ends of the openings remote of the hairpin winding are closed or have a reduced clear width that is smaller than the cross section of a pair of contacts. By providing an annular cover plate, for example, or reducing the clear width of the openings, the hairpin ends can be prevented from being pushed through the base body, which can impair the insulation and can possibly lead to problems with adjacent component parts.

A further aspect of the invention is an electric machine with a hairpin winding that is characterized in that an insulating unit according to one of the embodiment forms described above is provided. Accordingly, the electric machine has the characteristics described for the insulating unit, and a good insulation of the hairpin ends and a secure fastening of the insulating unit to the hairpin winding are ensured.

Further embodiment forms of an electric machine are characterized in that the openings are filled with a potting compound. As has already been described with respect to the insulating unit, the best possible insulation can be achieved through the construction with continuous openings because a potting compound is generated without entrapped air. By appropriate additions to the potting compound, the thermal conductivity of the potting compound can possibly be further increased so that the cooling of the hairpin winding can be improved.

According to one aspect of the invention, a method for producing an electric machine with an insulating unit comprises providing the hairpin winding, positioning the insulating unit on the hairpin winding, wherein the hairpin ends are positioned in the openings of the insulating unit, and introducing a potting compound in the openings proceeding from an axial direction, wherein the air escapes from the opposite end of the opening in axial direction. As has already been stated with respect to the insulating unit and electric machine, the winding, in particular the winding of the stator of an electric machine, is initially provided. A construction according to one aspect of the invention can also be used for a rotor or rotor and stator of an electric machine. The insulating unit is positioned on the winding head of the hairpin winding to produce an alignment of the hairpin ends and the connection pins with respect to the openings and the interconnection. The continuous openings ensure that when potting compound is introduced from an axial end of the openings the air can escape from the opposite end of the opening and no entrapment of air can accordingly occur. A uniform insulation of the hairpin ends is achieved in this way.

Embodiment forms of the method are characterized in that an interconnection is placed on the insulating unit, and the connection pins are electrically conductively connected to the interconnection. By means of the interconnection, the coils of the hairpin winding can be supplied with current in order to operate the electric machine.

Preferred embodiment forms of a method are characterized in that the potting compound is introduced after mounting the interconnection. By potting after the interconnection is mounted, this interconnection can advantageously be potted together with the insulating unit. This has the advantage that, when potted together, an additional connection is carried out between the interconnection and insulating unit and an insulation of the interconnection is produced at the same time.

The interconnection is preferably mounted on projections which are provided at the insulating unit so that the interconnection is spaced apart from the insulating unit. This spacing prevents contact between the interconnection and the contact pairs. Further, the continuous openings remain accessible from both axial ends via the spacing, which allows the potting compound to be introduced and air to escape.

### BRIEF DESCRIPTION OF THE DRAWINGS

The invention will be described more fully in the following referring to figures Like or similar component parts are designated by consistent reference numerals. In particular, the figures show:

FIG. 1 is an insulating unit;

FIG. 2 is a section through an insulating unit in the installed state;

FIG. 3 is an enlarged detail of an insulating unit; and

FIG. 4 is an enlarged detail of an insulating unit.

### DETAILED DESCRIPTION OF THE PRESENTLY PREFERRED EMBODIMENTS

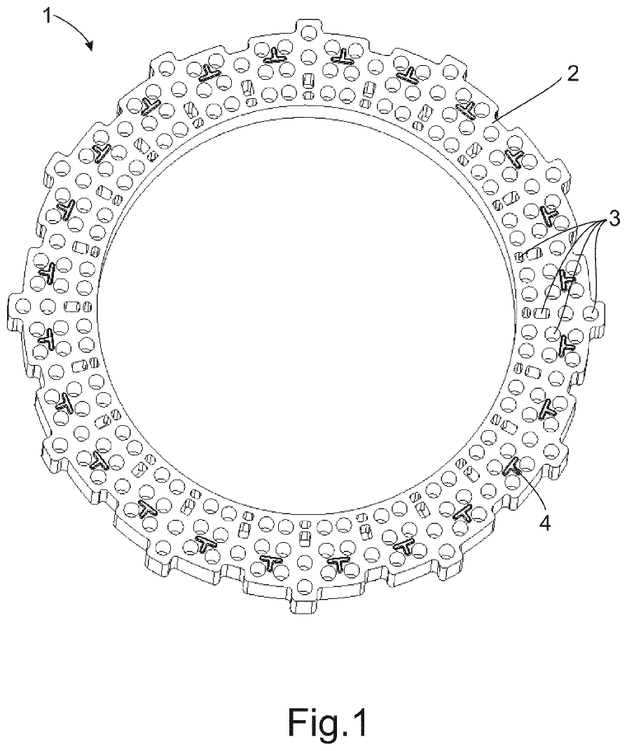

FIG. 1 shows an embodiment form of an insulating unit 1 in a perspective view. The insulating unit 1 comprises a base body 2 which has a plurality of openings 3. The openings 3, which are continuous in axial direction, are arranged adjacent to one another in a plurality of concentric diameters corresponding to the layers of the winding of the electric machine for receiving a hairpin end 7, which is not shown in FIG. 1. The depicted construction is carried out in the form of a circular ring extending over 360°. Alternative arrangements as solid-surface disk, for example, for rotor windings or in case a simultaneous covering of the inner area is to be provided, are also possible. Correspondingly, circle segments or ring segments extending along only a portion of the circumference are also possible, in which cases portions of the hairpin ends are possibly not insulated or a plurality of insulating units 1 distributed along the circumference are used. Partitioned constructions may be advantageous particularly for electric machines with large diameters.

The depicted openings 3 have a round cross section for the most part but can also have rectangular or other polygonal cross sections. In this regard, however, the cross-sectional area must be greater than the cross section of a pair of hairpin ends 7 that are connected to one another. The cross section may be formed smaller only in the openings 3 for the passage of the connection pins 6, but this cross section must still be larger than the cross section of the connection pins 6.

In the depicted example, the openings 3 for the connection pins 6 are formed at the inner circumference as rectangular openings 3. Depending on the winding, the connection pins 6 can also be arranged at the outer circumference or at both circumferential surfaces and/or in the center.

Further, the example shown in FIG. 1 has a plurality of projections 4 distributed over the circumference at its upper side remote of the winding. The projections 4 are T-shaped and are provided between the openings 3 so that, for example, an interconnection 8 following in axial direction is supported at a distance from the base body 2 and, therefore, so as to form a gap between the component parts. The projections 4 are arranged, respectively, in circumferential direction between the openings for the connection pins 6 and in the opposite edge area, in this case in the outer circumferential area, so that, especially for the connection pins 6, air gaps or space for insulating potting compound are maintained and creepage distances are prevented.

In the depicted example, the outer circumferential surface of the base body 2 is provided with optional protuberances and slots which, apart from saving on weight, can also be used with corresponding complementary pieces at a housing 9 as positioning aids during assembly and/or for preventing rotation in the installed state.

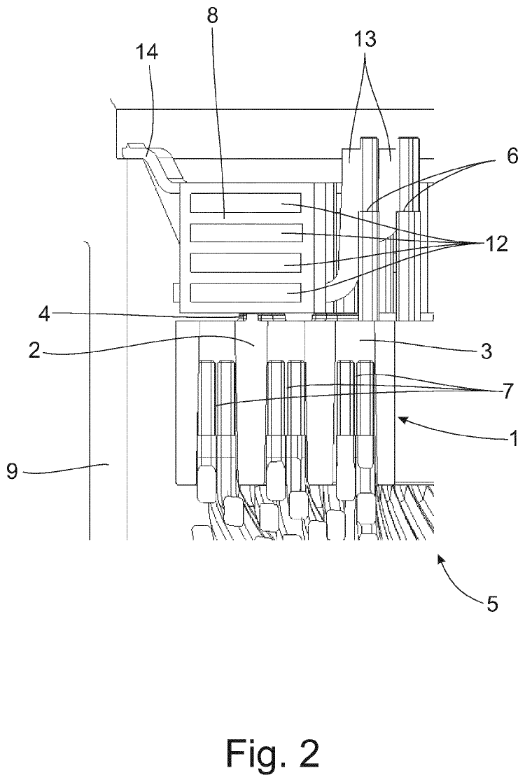

An upper partial area of a stator with winding head is shown in section in FIG. 2. The winding head in this respect is the one hairpin winding in which a plurality of shaped rods are arranged with their contact points correspondingly in pairs and are electrically conductively connected to one another so as to form the hairpin ends 7. As a result of the connections at the hairpin ends 7, the coils of the hairpin winding are formed from the shaped rods, these coils having individual connection pins 6 at the coil ends, respectively. The hairpin ends 7 are received in the continuous openings 3 of the base body 2. The hairpin ends 7 terminate inside the openings 3 and accordingly do not protrude over the base body 2. In contrast, the connection pins 6, which are also received in openings 3, protrude over the base body 2.

The connection pins 6 are connected to an interconnection 8, which is mounted on the insulating unit 1, and by which the various connection pins 6 are correspondingly interconnected to one another and to power electronics. In the depicted example, the interconnection 8 is formed from a plurality of annular conductors 12 which are arranged adjacent to one another in axial direction and are insulated with respect to one another and have contact points 13 protruding in direction of the connection pins 6. The contact points 13 are electrically conductively connected, preferably welded, to the connection pins 6.

The interconnection 8 is supported on the axial projections 4 of the base body 2 of the insulating unit 1. The projections 4 ensure that a free gap remains between the interconnection 8 and base body 2 so that when introducing a potting compound, not shown, air can escape from the openings 3 and potting compound can flow into the openings 3. In this way, it is ensured that no air can be trapped in the potting compound which could reduce the insulating effect.

In the depicted example, the interconnection 8 comprises likewise optional supporting arms 14 which are supported at the housing 9 of the electric machine in order to facilitate positioning of the interconnection 8.

The interconnection 8 can also be constructed differently, for example, with coaxially arranged conductor sleeves, depending on the design of the electric machine.

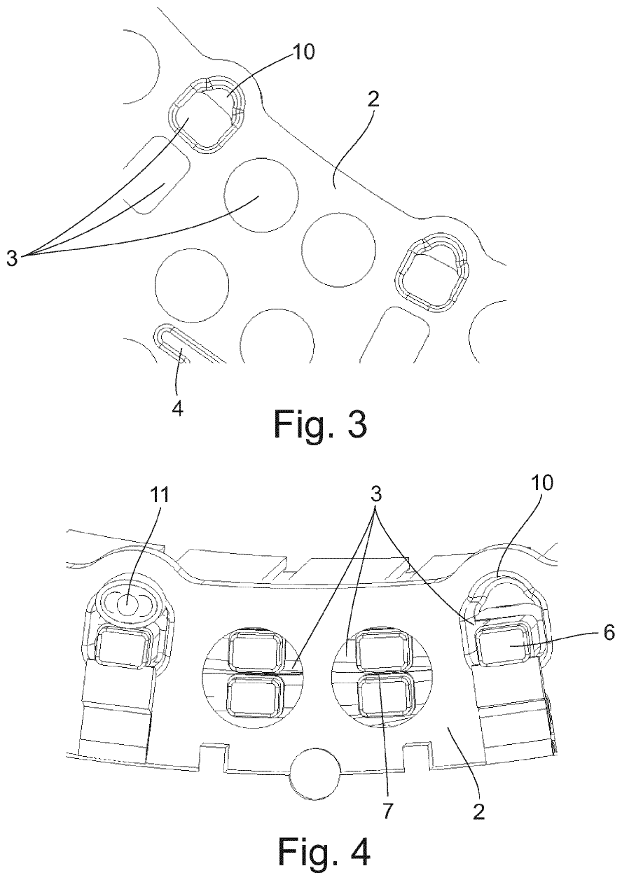

FIG. 3 shows a partial area of an insulating unit 1 according to an embodiment example. In this respect, the drawing shows the base body 2 with openings 3 and a projection 4 which is partially visible at the upper side. Round and rectangular openings 3 for receiving hairpin ends 7 are shown. Also shown are openings 3 through which the connection pins 6 pass through the base body 2 so as to be electrically conductively connected with the contact points 13 of the interconnection 8.

The openings 3 for the passage of the connection pins 6 have a widening 10 at their upper side. Accordingly, these openings 3 have a larger cross section at the upper side which decreases along the axial extension of the opening 3. The widening 10 allows a temperature sensor 11 to be received in the opening 3 along with the connection pin 6. Due to the fact that the cross section becomes narrower, the temperature sensor 11 is prevented from being pushed through the opening 3 and is accordingly positioned. Owing to a continuously narrowing cross section, the tip of the temperature sensor 11 is moved closer to the connection pin 6 at the same time so as to achieve measurements which are as precise as possible. Alternatively, the widening 10 can also extend over the entire axial length of the opening 3 or can have a discontinuous change in cross section instead of a continuous change.

Contrary to the example in FIG. 1, the insulating unit 1 can also extend only over a circumferential area of the hairpin winding in which the connection pins 6 are located. Depending on the design layout of the electric machine, a simple insulation of the hairpin ends 7 may be sufficient without an insulating unit 1 in this region because they can be sufficiently spaced apart from one another over the further course of the circumference. Alternatively, the rest of the circumference could be insulated with at least one further insulating unit, for example.

FIG. 4 shows a partial area of a further embodiment example, wherein the base body 2 is formed narrower in radial direction.

Such embodiment forms can be utilized not only as hairpin windings but with a correspondingly small quantity of layers also to cover only a portion in radial direction. For example, an insulating unit 1 can be used only for the two inner layers, referring to the depicted example, in which connection pins 6 are arranged. In this way, a modular construction can also be made possible in which an insulating unit 1 is composed of a plurality of annular or ring segment-shaped insulating units with different diameters. For improving the positioning of the individual segments relative to one another in a modular construction of this kind, slots or corresponding protuberances are preferably provided at the circumferential surfaces to enable a positive engagement one inside the other. The individual segments may be joined with one another via separate connection means such as screws, clamps or adhesive. The potting compound introduced further on in the process can also serve as connection means.

FIG. 4 likewise shows openings 3 for connection pins 6 with a widening 10 according to FIG. 3, wherein a temperature sensor 11 is arranged at a connection pin 6. Depending on construction, redundancy, costs and the like, any quantity of temperature sensors 11 may be provided at the hairpin winding.

The invention is not limited to the described embodiments. As stated above, advantageous features may be provided merely singularly, or various exemplary features may be combined.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-14. (canceled)

15. An insulating unit for an electric machine with hairpin winding, the hairpin winding having a plurality of connection pins that electrically connect to an interconnection and a plurality of welded hairpin ends that form contact pairs, the insulating unit comprising:
a base body, which has an insulating material and extends at least over a portion of a circumference of the hairpin winding; and
continuous openings extending in an axial direction defined in the base body has, and in that each continuous opening is associated with a hairpin end or a connection pin.

16. The insulating unit according to claim 15, wherein the base body has projections at its side remote of the hairpin winding that serve as spacers for the interconnection.

17. The insulating unit according to claim 16, wherein the projections are uniformly distributed over the circumference.

18. The insulating unit according to claim 16, wherein the projections are not arranged directly adjacent to a respective continuous opening for a connection pin.

19. The insulating unit according to claim 16, wherein the projections are T-shaped.

20. The insulating unit according to claim 15, wherein at least one continuous opening has a widening for receiving a temperature sensor.

21. The insulating unit according to claim 20, wherein the widening narrows along an axial extension of the at least one continuous opening so that the temperature sensor abuts the hairpin winding.

22. The insulating unit according to claim 15, wherein the base body comprises a plurality of parts.

23. The insulating unit according to claim 16, further comprising:
a cover plate provided on the projections, or
ends of the continuous openings remote of the hairpin winding are closed or have a reduced clear width which is smaller than a cross section of a pair of contacts.

24. An electric machine comprising:
a hairpin winding; and
an insulating unit comprising:
a base body, which has an insulating material and extends at least over a portion of a circumference of the hairpin winding; and
continuous openings extending in an axial direction defined in the base body has, and in that each opening is associated with a hairpin end or a connection pin.

25. The electric machine according to claim 24, wherein the continuous openings are filled with a potting compound.

26. A method for producing an electric machine with an insulating unit, comprising:
providing a hairpin winding;
positioning an insulating unit on the hairpin winding, wherein hairpin ends are positioned in openings of the insulating unit;
introducing a potting compound in the openings proceeding from an axial direction,
wherein air escapes from an opposite end of the opening in axial direction.

27. The method according to claim 26, further comprising:
placing an interconnection on the insulating unit; and
electrically conductively connecting connection pins to the interconnection.

28. The method according to claim 27, further comprising:
introducing the potting compound after mounting the interconnection.
